(19) United States
(12) Patent Application Publication
(10) Pub. No.: US 2013/0262463 A1
(43) Pub. Date: Oct. 3, 2013

(54) METHOD AND SYSTEM TO PROVIDE SMART TAGGING OF SEARCH INPUT

(71) Applicants: Naren Chittar, San Jose, CA (US); Govind Kaushal, San Jose, CA (US); John Sheeley, San Francisco, CA (US); Jai Dandekar, San Jose, CA (US); Matthew Bret Maclaurin, Santa Cruz, CA (US); Bhanu Koppaka, San Jose, CA (US)

(72) Inventors: Naren Chittar, San Jose, CA (US); Govind Kaushal, San Jose, CA (US); John Sheeley, San Francisco, CA (US); Jai Dandekar, San Jose, CA (US); Matthew Bret Maclaurin, Santa Cruz, CA (US); Bhanu Koppaka, San Jose, CA (US)

(73) Assignee: eBay Inc., San Jose, CA (US)

(21) Appl. No.: 13/725,275

(22) Filed: Dec. 21, 2012

Related U.S. Application Data
(60) Provisional application No. 61/618,358, filed on Mar. 30, 2012.

(51) Int. Cl. G06F 17/30

(52) U.S. Cl. CPC G06F 17/30595
USPC 707/736

(57) ABSTRACT

Method and system to provide smart tagging of search input are described. In one example embodiment, as a user types search terms or keywords into a search box, a computer-implemented system for smart tagging links one or more keywords presented in the search box with an additional presentation. The additional presentation may include a hover window containing additional information associated with the keyword.

### TECHNICAL FIELD

This application relates to a method and system to provide smart tagging of search input.

### BACKGROUND

An on-line trading platform allows users to shop for almost anything using a web browser application. A user may find an item listed by an on-line trading application by entering keywords into the search box provided on an associated web page or by browsing through the list of categories on the borne page. After a list of search results is returned, a user may further refine a search using a list of filters provided in the right-side portion of the search results web page. A user may select an Item from the search results to view the details of the item. A user may then return to the search results page to further refine the search by using filters provided, in the right-side portion of the search results web page.

### BRIEF DESCRIPTION OF DRAWINGS

Embodiments of the present invention are illustrated by way of example and not limitation in the figures of the accompanying drawings, in which like reference numbers indicate .similar elements and in which:

FIG. 1 is a network diagram depicting a client-server system, within which one example embodiment may be deployed;

FIG. 2 is a block diagram of a system to provide smart tagging of search input, in accordance with one example embodiment;

FIG. 3 is a flow chart of a method to provide smart tagging of search input, in accordance with an example embodiment;

FIG. 4 shows a hover window presented on the user's display device in response to detecting a mouse-hover event associated with a tagged keyword in the search box, in accordance with an example embodiment;

FIG. 5 shows a further example of a hover window presented on the user's display device in response to detecting a mouse-hover event associated with a tagged keyword in the search box; and

FIG. 6 is a diagrammatic representation of an example machine in the form of a computer system within which a set of instructions, for causing the machine to perform any one or more of the methodologies discussed herein, may be executed.

### DETAILED DESCRIPTION

A method and system to provide smart tagging of search input is described. In the following description, for purposes of explanation, numerous specific details are set forth in order to provide a thorough understanding of an embodiment of the present invention. It will be evident, however, to one skilled in the art that the present invention may be practiced without these specific details.

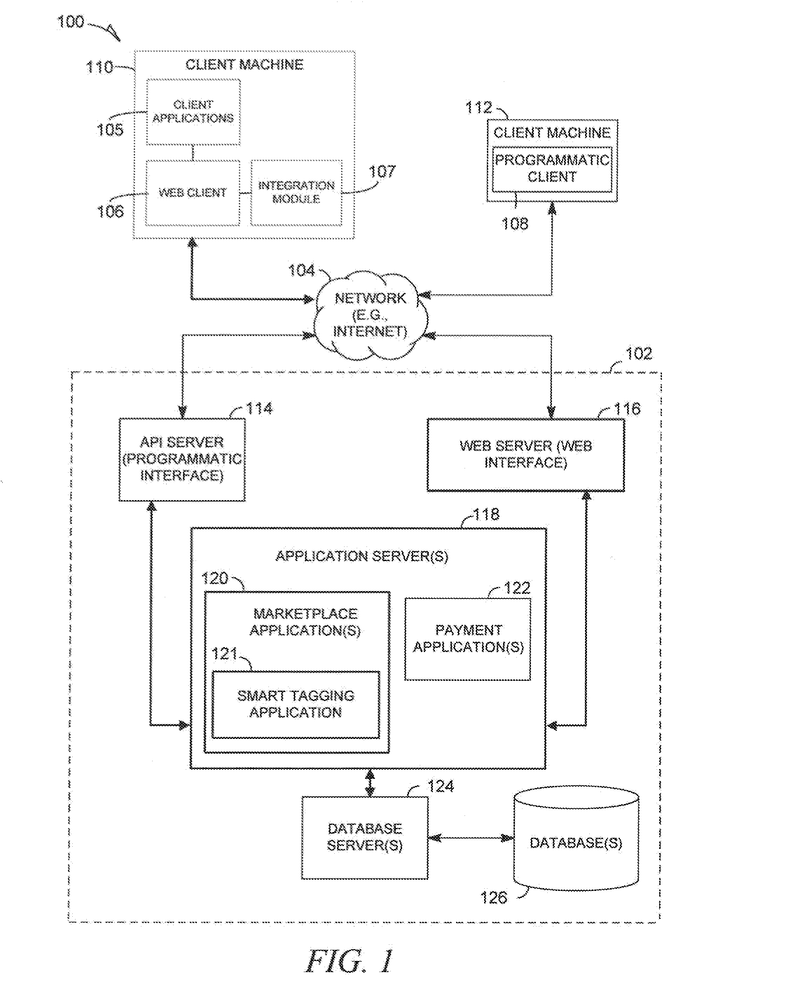

Embodiments of the present invention include approaches that enhance user's experience by anticipating the user's interest in information related to one or more search terms entered by the user. In some embodiments, the smart tagging system links an attribute from a listing to content or to another search term or attribute, to a web link, to a visual control (a user interface (UI) control), etc. When the system, encounters a keyword in a search box that corresponds to such linked attribute, the system tags that keyword by associating it with an additional presentation. Such additional presentation may be in the form of a hover window and may contain information such a list of related keywords, popular products among current listings associated with the keyword, a link to a web page associated with the keyword, etc. A search request may contain multiple keywords that could be tagged by the smart tagging, system. Example method and system to provide smart tagging of search input may be implemented in the context of a network environment 100 illustrated in FIG. 1, specifically as the smart tagging application 121.

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, client applications 105 (e.g., mobile applications), an integration module 107, and a web client 106 (e.g., a mobile or desktop Web browser) operating on the client machine 110 (e.g., a mobile device), as well as a programmatic client 108 operating on the client machine 112.

An application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions, and services to users that access the networked system 102. Shown in FIG. 1 is a smart tagging application 121 included as one of the marketplace applications 120. The smart tagging application 121 may be utilized beneficially to link search keywords to context. Item listing attributes, and/or other information, as described herein.

The payment applications 122 may provide a number of payment services and functions to users. The payment applications 122 may allow users to accumulate value (e.g., in a commercial currency, such as the U.S. dollar, era proprietary currency, such as “points”) in accounts, and then later to redeem the accumulated value for products (e.g., goods or services) that are made available via the marketplace applications 120. While the marketplace and payment applications 120 and 122 are shown in FIG. 1 to both term part of the networked system 102, it will be appreciated that, in alternative embodiments, the payment applications 122 may form part of a payment service that is separate and distinct from the networked system 102.

Further, while the system 100 shown in FIG. 1 employs client-server architecture, the subject matter of the application is of course not limited to such an architecture, and could equally well, find application in a distributed, or peer-to-peer, architecture system, for example. The various marketplace and payment applications 120 and 122 could also be implemented as standalone software programs, winch do not necessarily have networking capabilities.

The web client 106 accesses the various marketplace and payment applications 120 and 122 via the web interlace supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on she networked system 102 in an off-line manner, and to perform hatch-mode communications between the programmatic client 108 and the networked system 102.

The integration module 107 on the client machine (e.g., a mobile phone) may submit requests to the marketplace applications 110, through the API server 114, for an up-to-date (e.g., current) publication related to goods and/or services being offered for sale via the networked system 102. A publication related to goods and/or services being offered for sale may also be termed an item listing. Alternatively or additionally the client machine 110 may request one or more current publications from the client machine 112, via the network 104. In various example embodiments, the client machine 112 may provide a current publication to the client machine 110, after generating the current publication or retrieving such a publication from the networked system 102.

In some example embodiments, the integration module is embedded within one or more of the client applications 105 and may collect user parameters, receive targeted current publications based on the user parameters, and cause the display of one or more targeted current publications. A targeted current publication may he displayed among graphics associated with the application In which the integration module is embedded.

The applications 120, including the smart tagging application 121, may be hosted on dedicated or shared server machines (not shown) that are communicatively coupled to enable communications between server machines. The applications themselves are communicatively coupled, (e.g., via appropriate interfaces) to each other and to various data sources, so as to allow information to be passed between the applications or so as to allow the applications to share and access common data. The applications may furthermore access server one or more databases 126 via the database servers 128.

The networked system 102 may provide a number of publishing, listing and price-setting mechanisms whereby a seller may list (of publish information concerning) goods or services for sale, a buyer can express interest in or indicate a desire to purchase such goods or services, and a price can be set for a transaction pertaining to the goods or service.

In one example embodiment, as a user types search terms or keywords into a search box, the system for smart tagging (e.g., the smart tagging application 121 of FIG. 1) tags certain keywords, such as brand names or sizes, in one embodiment, the tagging may be effectuated by linking a keyword presented in the search box with an additional presentation. Such additional presentation may include a hover window containing additional information associated with the keyword that may be of interest to the user.

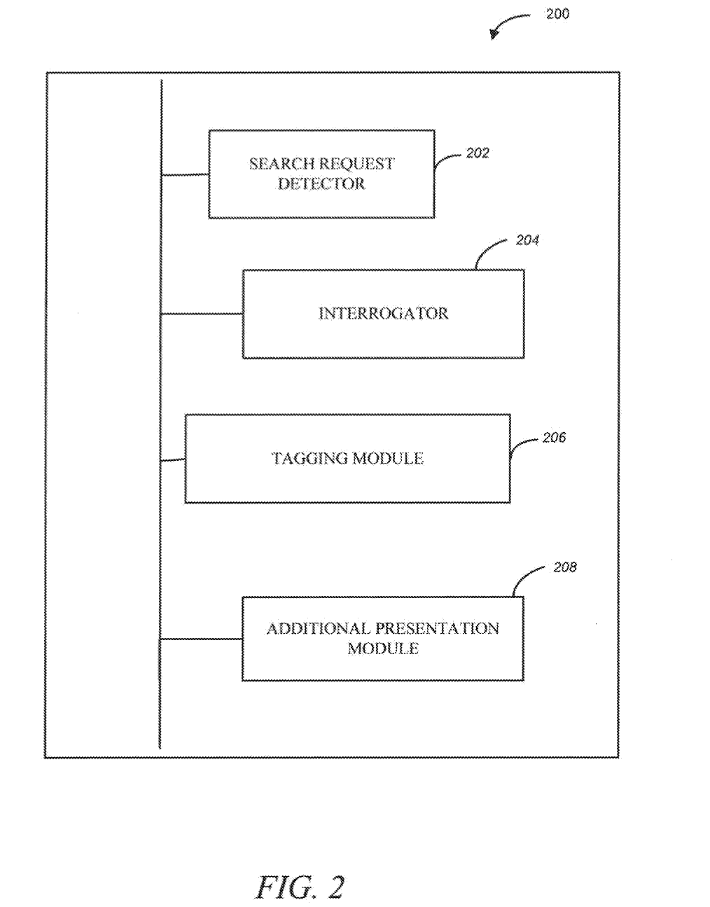

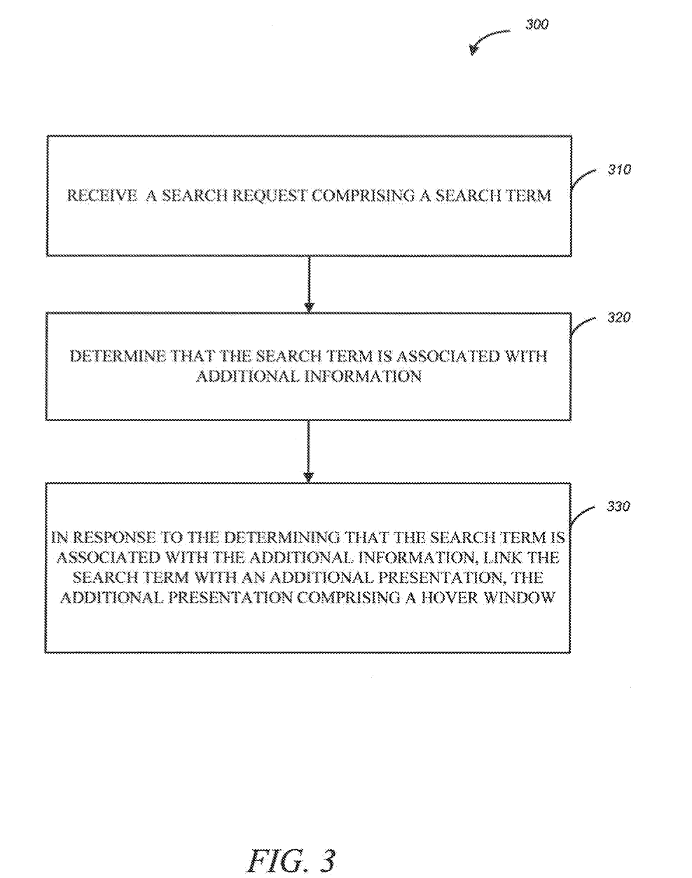

FIG. 2 is a block diagram, of a system 200 to provide smart tagging of search input, in accordance with one example embodiment. As shown in FIG. 2, the system 200 includes a search request detector 202, an interrogator 204, and a tagging module 206. The search request detector 202 may be configured to detect a search request comprising a search term. The interrogator 204 may be configured to determine whether the search term is associated with additional information. The tagging module 206 may be configured to link the search term with an additional presentation in response to determining that the search term is associated with the additional information. The additional presentation may comprise a hover window. A hover window may include a save visual control. A save visual control may be configured to generate an association between two terms from the search request and to save the association in a profile of a user associated with the search request. For example, the two terms in a search request may be a brand name and a size. A user may select to save. In their profile an association between the brand and the size values. An example method to provide smart tagging of search input can be described with reference to FIG. 3.

FIG. 3 is a flow chart of a method 300 to provide smart tagging of search input, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 118 of FIG. 1 and, specifically, at the system 200 shown in FIG. 2.

The method 300 commences at operation 310, when the search request, detector 202 of FIG. 2 defects a search request comprising a search term. The interrogator 204 of FIG. 2 determines whether the search term is associated with additional information at operation 320. At operation 330, the tagging module 206 of FIG. 2 links the search term with an additional presentation in response to determining that the search term is associated with the additional information that may comprise a hover window.

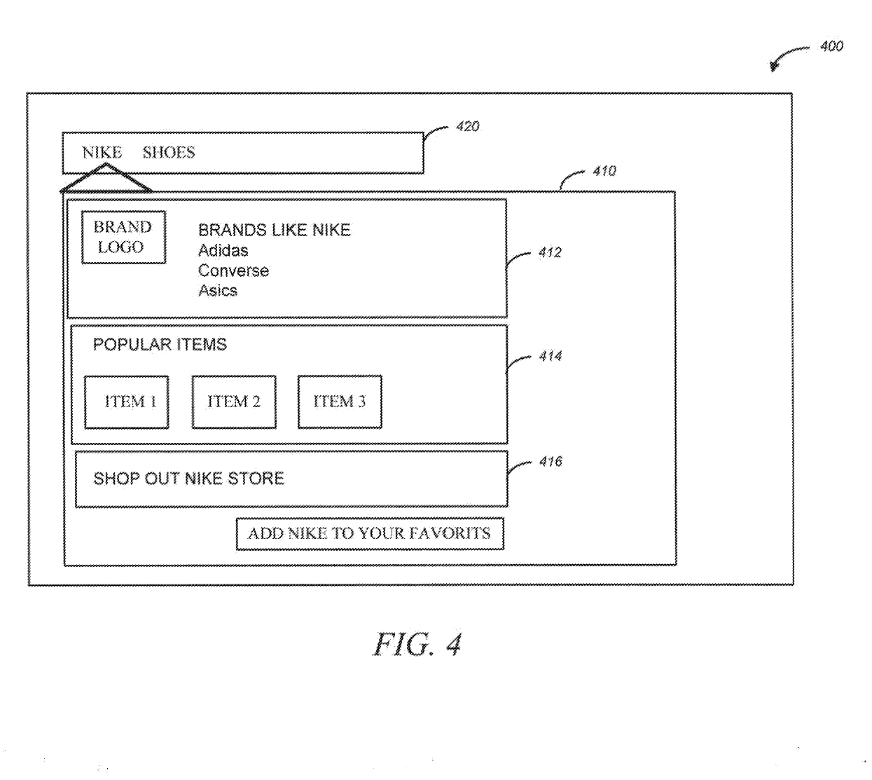

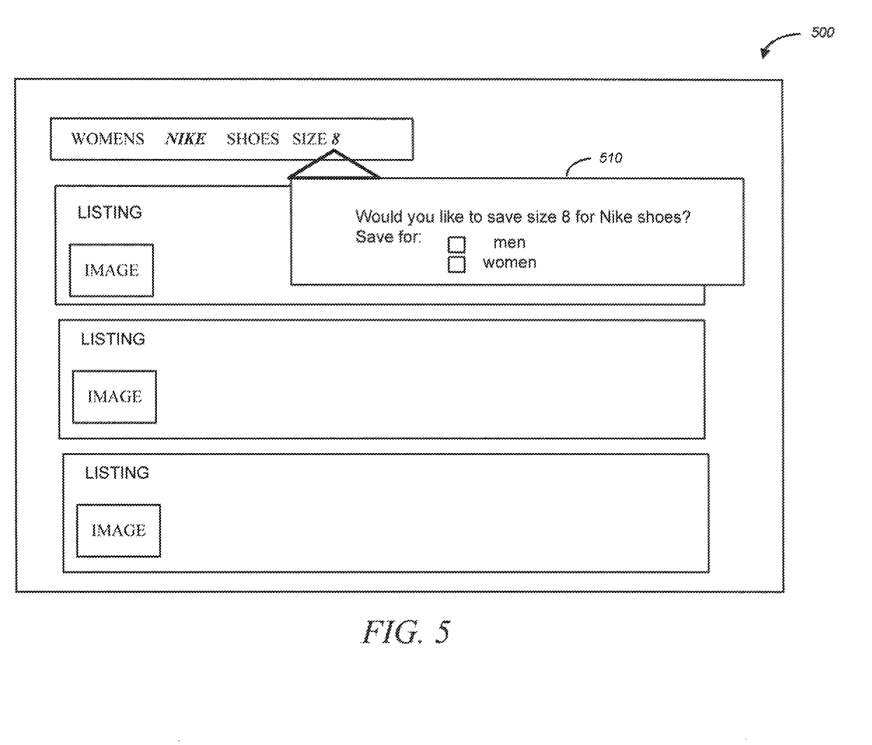

FIG. 4 shows a user interface 400 including a hover window 410 that may be presented on the user's display device in response to detecting a mouse-hover event associated with a tagged keyword in a search box 420. In the example shown in FIG. 4, on a mouse-hover over a tagged keyword that is a brand name (“NIKE”), the user is presented with a list of other brands (“Adidas,” “Converse,” and “Asics”) in a display area 412. The hover window 410 also presents one or more popular products among current listings associated with the tagged keyword (in a display area 414), a link 410 to access the brand page on the associated on-line trading platform, and an option to include the brand name associated with the tagged keyword to the user's profile as a “Favorite.” FIG. 5 shows a user interface 500 including a hover window 510 that provides a user with an option to save the size information in their profile.

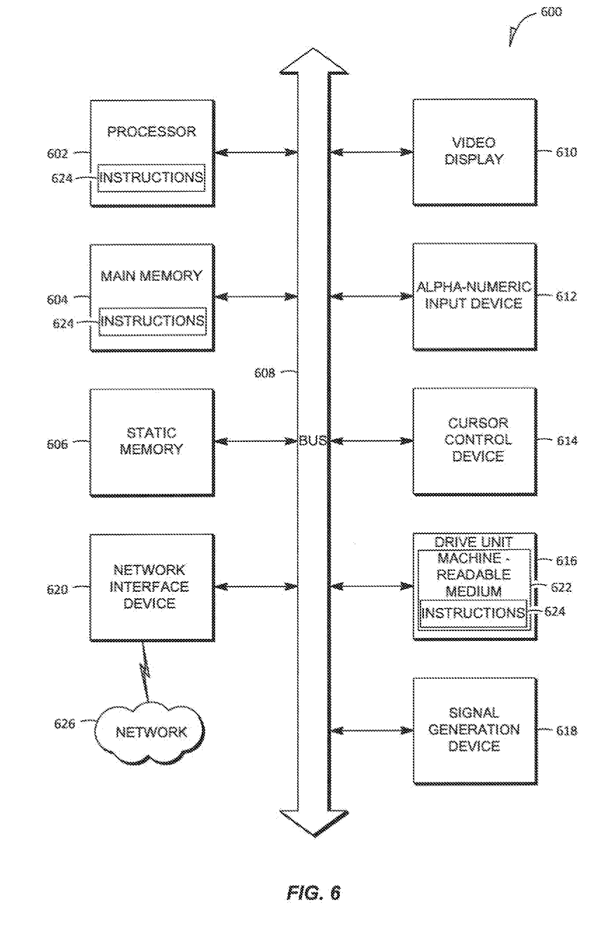

FIG. 6 is a diagrammatic representation of a machine in the example form of a computer system 600 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing, a set of instructions (sequential or otherwise) that specify actions to be taken by that machine. Further, white only a single machine is illustrated, the term “machine” shall also be taken to include any collection of machines that individually or jointly execute a set (or multiple sets) of instructions to perform any one or more of the methodologies discussed herein.

The example computer system 600 includes a processor 603 (e.g., a central processing unit (CPU), a graphics processing unit (GPU) or both), a main memory 604 and a static memory 606, which communicate with each other via a bus 606. The computer system 600 may further include a video display unit 610 (e.g., a liquid crystal display (LCD) or a cathode ray tube (CRT)). The computer system 600 also includes an alpha-numeric input device 612 (e.g., a keyboard), a user Interface (UI) navigation device 614 (e.g., a cursor control device), a disk drive unit 616, a signal generation device 618 (e.g., a speaker) and a network interface device 620.

The disk drive unit 616 includes a machine-readable medium 622 on which is stored one or more sets of Instructions and data structures (e.g., software 624) embodying of utilized by any one or more of the methodologies or functions described herein. The software 624 may also reside, completely or at least partially, within the main memory 604 and/or within, the processor 602 during execution thereof by the computer system 600, with the main memory 604 and the processor 602 also constituting machine-readable media.

The software 624 may further be transmitted or received over a network 626 via the network interface device 620 utilizing any one of a number of well-known transfer protocols (e.g., Hyper Text Transfer Protocol (HTTP)),

While the machine-readable medium 632 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer. In hardware, or in a combination of software and hardware. Such embodiments of die inventive subject matter may be referred to herein, individually or collectively, by the term “invention” merely for convenience and without intending to voluntarily limit the scope of this application to any single invention or inventive concept if more than one is, in fact, disclosed.

Modules, Components and Logic

Certain embodiment are described herein as including logic or a number of components, modules, or mechanisms. Modules may constitute either software modules (e.g., code embodied (1) on a non-transitory machine readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured, (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwared) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need, not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented, module at one instance of time and to constitute a different hardware-implemented module at a different instance of time,

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules, in embodiments in which multiple hardware-implemented modules are configured or instantiated, at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one of more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces; (e.g., Application Program Interlaces (APIs).)

Thus, method, and system to provide smart tagging of search Input have been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A system comprising:
at least one processor coupled to a memory;
a marketplace module to maintain a plurality of item listings, each item listing from the plurality of item listings comprising one or more attributes;
a linked attribute module to link a search term with an attribute of an item listing from the plurality of item listings;
a search request detector to detect, using the at least one processor, a search request comprising a search term, the search request directed to a network-based marketplace system;
an interrogator to determine, using the at least one processor, whether the search term is linked to the attribute; and
a tagging module to link, using the at least one processor, the search term with an additional presentation, the additional presentation comprising additional information related to one or more listings from the plurality of listings, in response to determining that the search term is linked to the attribute.

2. The system of claim 1, the attribute is linked to one or more of: another search term, another attribute from the one or more listings, a web link, and a visual control, the visual control being an actionable user interface element.

3. The system of claim 1, wherein the additional presentation comprises a save visual control, the save visual control being a user interface element actionable to generate an association between two terms from the search request and to save the association in a profile of a user associated with the search request.

4. The system of claim 1, wherein the additional presentation comprises a hover window.

5. The system of claim 1, comprising an additional presentation module to, using at least one processor:
detect a hover event associated with the search term; and
present, on a display device, a hover window associated with the search term.

6. The system of claim 5, wherein the hover window comprises a list of additional search terms, the additional search terms being from a category associated with the keyword.

7. The system of claim 5, wherein the hover window comprises one or more images associated with the keyword.

8. The system of claim 5, wherein the hover window comprises a link to a web page associated with the keyword.

9. The system of claim 5, wherein the hover window is overlayed over a presentation of search results provided in response to the search request.

10. The system of claim 1, wherein:
the interrogator is to determine whether a further search term is associated with additional information; and
the tagging module is to link the further search term with further additional presentation.

11. A method comprising:
in a network-based marketplace system, maintaining a plurality of item listings, each item listing from the plurality of item listings comprising one or more attributes;
linking a search term with an attribute of an item listing from the plurality of item listings;
receiving, using at least one processor, a search request comprising a search term, the search request directed to the network-based marketplace system;
determining that the search term is linked to the attribute; and
in response to the determining that the search term is linked to the attribute, linking the search term with an additional presentation, the additional presentation comprising additional information related to one or more listings from the plurality of listings.

12. The method of claim 11, wherein the attribute is linked to one or more of: another search term, another attribute from the one or more listings, a web link, and a visual control, the visual control being an actionable user interface element.

13. The method of claim 12, wherein the additional presentation comprises a save visual control, the save visual control being a user interface element actionable to generate an association between two terms from the search request and to save the association in a profile of a user associated with the search request.

14. The method of claim 11, wherein the additional presentation comprises a hover window.

15. The method of claim 11, comprising:
detecting a hover event associated with the search term; and
presenting, on a display device, the a hover window associated with the search term.

16. The method of claim 15, wherein the hover window comprises a list of additional search terms, the additional search terms being from a category associated with the keyword.

17. The method of claim 15, wherein the hover window comprises one or more images associated with the keyword.

18. The method of claim 15, wherein the hover window comprises a link to a web page associated with the keyword.

19. The method of claim 15, wherein the hover window is overlayed over a presentation of search results provided in response to the search request.

20. A machine-readable non-transitory storage medium having instruction data to cause a machine to:
maintain a plurality of item listings, each item listing from the plurality of item listings comprising one or more attributes;
link a search term with an attribute of an item listing from the plurality of item listings;
detect a search request comprising a search term, the search request directed to a network-based marketplace system;
determine whether the search term is linked to the attribute; and
link the search term with an additional presentation, the additional presentation comprising additional information related to one or more listings from the plurality of listings, in response to determining that the search term is linked to the attribute.
